(19) United States
(12) Patent Application Publication
(10) Pub. No.: US 2008/0043274 A1
(43) Pub. Date: Feb. 21, 2008

(54) Secure printing system with privilege table referenced across different domains

(76) Inventors: Lida Wang, Concord, CA (US); David Chamberlin, Port Costa, CA (US)

Correspondence Address: Kyocera Technology Development;Intellectual Property Administration, Suite 400, 1855 Gateway Blvd., Concord, CA, 94520, US

(21) Appl. No.: 11/505,035

(22) Filed: Aug. 16, 2006

(51) Int. Cl. G06K 15/00

(52) U.S. Cl. 358/1.14

(57) ABSTRACT

A method for secure printing, comprising: job-issuing user entering to job-issuing package user identification and access rights for job-receiving users, and destination print server; creating privilege table comprising allowable action profiles, and sending the print job with attached privilege table to print server; job-receiving user entering into MFP user identification and print server; MFP retrieving print job with the attached privilege table; and upon verifying legality of the action, releasing the print job. Job-receiving users in possibly different domains have access rights of print only, print and delete if last, and print and send acknowledgement back. Privilege table may contain user-specified threshold retention-period value which along with threshold capacity value is used to delete oldest jobs in print server. Methods also include entering user management server; job-issuing package and MFP authenticating itself to authentication server; the authentication server requesting an access ticket from second authentication server, receiving and decrypting encrypted access ticket, encrypting access ticket with a key known to job-issuing package, and sending it to job-issuing package.

### FIELD OF THE INVENTION

This invention relates to secure communication of a print job to a printing device, and more particularly to a secure printing system using a privilege table that is referenced across different domains.

### BACKGROUND OF THE INVENTION

When one intends to print a confidential document, it is undesirable for a random person in the office who happens to be walking by to see the document or a coworker to pick up and carry away the document by mistake. One way to avoid this undesirable situation is to require that identification information is entered into a printing device or an MFP. This identification information needs to be authenticated using a password or other means of identification. However, problems of identification, authentication, and secure communication are multiplied when multiple domains are involved. The multiple domains may even involve domains in different countries or continents, with different servers in different domains. Moreover, there are issues of multiple recipients of a print job. Sometimes, the job-issuing user and the job-receiving user may not be the same individual. Indeed, there may be situations where the job-issuing user may want to specify multiple job-receiving users, i.e., a group of users (perhaps in different domains) may be given access to print and read a particular confidential document. The present invention arose out of the above perceived needs and concerns associated with secure communication of printing jobs involving multiple users and possibly involving communication across different domains.

### SUMMARY OF THE INVENTION

Methods, computer program products, computing and printing systems for secure communication of a print job to a printing device using a privilege table that is referenced across different domains are described. Using the methods of the present invention, a print job can be issued to one or more print servers that sit in the same or different domain as the domain of the host computer that issues the job. A print job can be released to the MFP that sits in the same or different domain as the domain of the print server that stores the print job. Using the methods of the invention, the user who issues a print job can be the same or different user who retrieves the print job. Even if job issuer and receiver is the same user, he also can retrieve the print job from the MFP that sits in the different domain with the one where he issues the print job.

For each printable job, we provide a privilege table that allows different user across different domains to have different access right to this file. The access rights include: print only, print and delete if last, print and save, print and send acknowledgement message back to the job issuer, etc. depending on the information sensitivity of the print job. In a sample privilege table for a print job, User1 in Domain1 may be given the access right of Print only, User3 in another Domain may be given the access right of Print & delete if last, and User1 in yet another domain DomainN may be given the access right of Print and send acknowledgement back.

The print job with attached privilege table sent to the destination print server can be retrieved by at least two job-receiving users using at least two printing devices sitting in different domains, each of which domains contains its own authentication server. This is made possible using the methods involving entries each of which specifies the domains, users, and access rights for the print job, and the methods of communicating with the authentication server of each domain of the present invention.

The invention will be more fully understood upon consideration of the detailed description below, taken together with the accompanying drawings.

### DESCRIPTION OF THE DRAWINGS

FIG. 1 is a simplified block diagram showing connection of a computing system to a printer, in accordance with a preferred embodiment of the present invention.

FIG. 2 is a flowchart showing the processing steps for ajob issuing procedure, in accordance with a preferred embodiment of the present invention.

FIG. 3 is a flowchart showing the processing steps for the authentication server SA issuing Pjob an access ticket for other servers S such as print servers and management servers, in accordance with a preferred embodiment of the present invention.

FIG. 4 shows a sample privilege table, in accordance with a preferred embodiment of the present invention.

FIG. 5 is a flowchart showing the processing steps for a procedure of an MFP retrieving and releasing a print job from a server, in accordance with a preferred embodiment of the present invention.

FIG. 6 is a flowchart showing the processing steps for a procedure of authentication server issuing an MFP an access ticket for other print servers or user management servers, in accordance with a preferred embodiment of the present invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

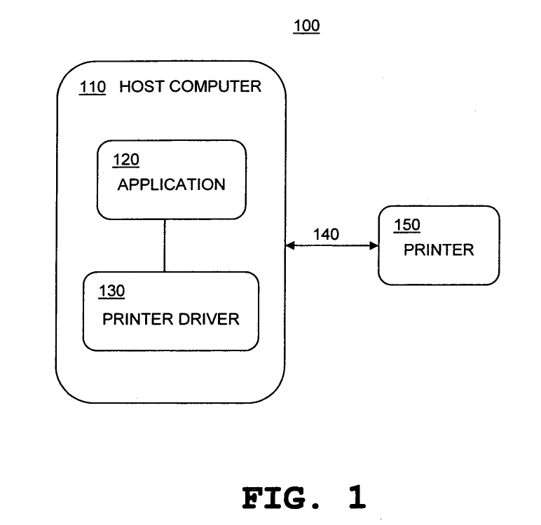

FIG. 1 is a simplified block diagram showing connection of a computing system to a printer, in accordance with a preferred embodiment of the present invention. FIG. 1 shows a general printing system setup 100 that includes a host computer 110 and a printer 150. Here, the printer 150 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 110 includes an application 120 and a printer driver 130. The application 120 refers to any computer program that is capable of issuing any type of request, either directly or indirectly, to print information. Examples of an application include, but are not limited to, commonly used programs such as word processors, spreadsheets, browsers and imaging programs. Since the invention is not platform or machine specific, other examples of application 120 include any program written for any device, including personal computers, network appliance, handheld computer, personal digital assistant, handheld or multimedia devices that is capable of printing.

The printer driver 130 is a software interfacing with the application 120 and the printer 150. Printer drivers are generally known. They enable a processor, such as a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 140 is provided and permits host computer 110 to communicate with a printer 150. Printer 150 is configured to receive print commands from the host computer and, responsive thereto, render a printed media. Various exemplary printers include laser printers that are sold by the assignee of this invention. The connection 140 from the host computer 110 to the printer 150 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

The present invention is suited for printer drivers, and it is also suited for other device drivers. The above explanations regarding FIG. 1 used a printer driver rather than a general device driver for concreteness of the explanations, but they also apply to other device drivers. Similarly, the following descriptions of the preferred embodiments generally use examples pertaining to printer driver, but they are to be understood as similarly applicable to other kinds of device drivers.

In this invention, we present a secure printing method that breaks the boundary of domain restriction among print job issuer, print job receiver and print server that stores the print jobs. In this method, a print job can be released to a MFP that sits in the same or a different domain with the host computer that issues the print job. The user who issues a print job can be the same or different user who retrieves the print job, also even if job issuer and job receiver are the same user, the receiver can still retrieve the print job in location that sit in a different domain with the one he issues the print job. Moreover, each print job is accompanied with one privilege table created by the job issuer. The privilege table states different access right to the print job among different receiver across different domains, thus allowing multiple domain-crossing intended job receiver to retrieve the print job from one print server. While the method of this invention may be used with any number of different types of servers, the invention will be described for convenience including at least one Kerberos authentication server, one print server and one user management server in each domain.

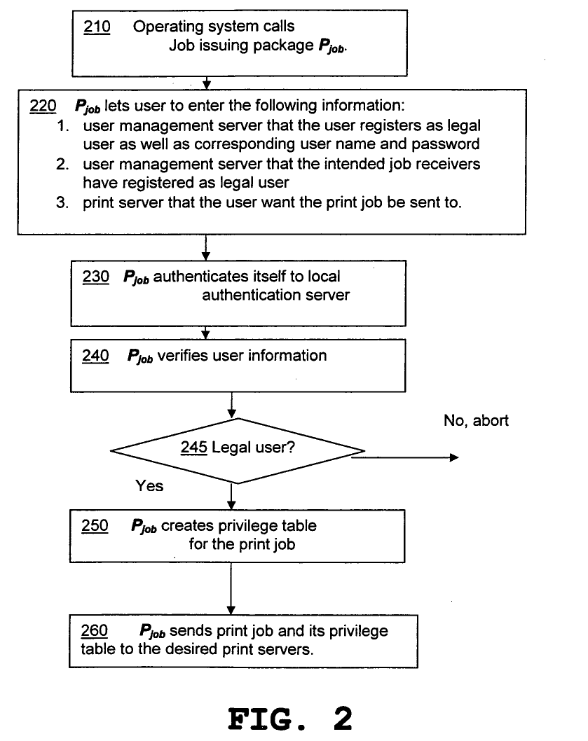

FIG. 2 is a flowchart showing the processing steps for a job issuing procedure, in accordance with a preferred embodiment of the present invention. The procedure of job issuing is illustrated in FIG. 2 as well as described as follows.

In Step 210, the Job issuing package (from now on, referred as Pjob) is called after printable raw data is produced by the cooperation of application and Operating System's print service. In Windows Operating System, by Operating System's print service, we mean windows spooler and each manufacture's own print driver. Also in Windows Operating System, Pjob may sits in the driver, port monitor, language monitor or print provider.

In Step 220, Pjob requires the user to enter the following information.

Step 2.1. Information of user management server (Ss) that the user has registered as a legal user as well as the corresponding user name and password.

Step 2.2. Information of user management servers (Sr1, . . . , Sm) that the intended job receivers has registered as legal users.

Step 2.3. Information of Print servers (Sp1, . . . , Spm) to which the user wants the print job to be sent.

In Step 230, Pjob authenticates itself to the authentication server SA that sits in the same domain as Pjob. By SA authenticating Pjob, we mean SA issues a shared secret key for future encrypted communication. This shared secret is encrypted by a pre-shared secrete between Pjob and SA.

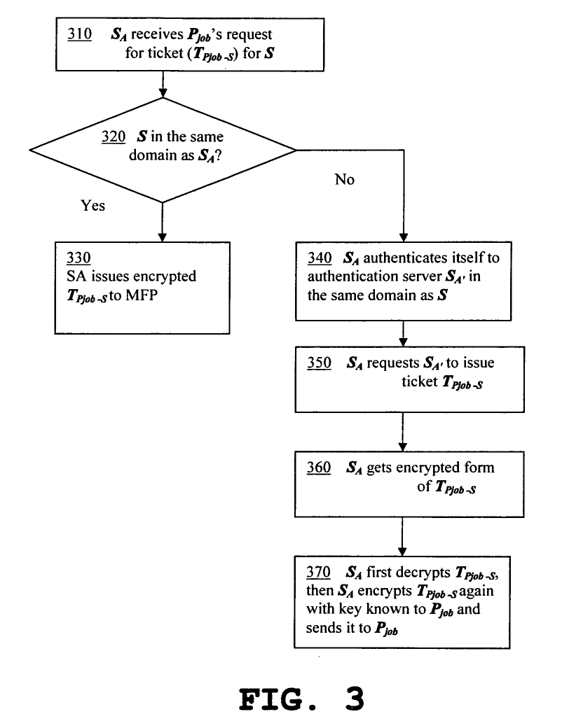

FIG. 3 is a flowchart showing the processing steps for the authentication server SA issuing Pjob an access ticket for other servers S such as print servers and management servers, in accordance with a preferred embodiment of the present invention. From this point on, the future communication between Pjob and SA will be SA issuing Pjob access ticket to some other server S based on Pjob's request in the following way: first, Pjob asks SA for the access ticket for other server S such as user management server and print server in the same or different domain, then SA replies Pjob with the access ticket encrypted by the shared secret between SA and Pjob. If the server S is in a different domain, then SA has to connect to the authentication server SA′ that sits in the same domain as S first. The procedure of how SA issues Pjob access ticket for S is better illustrated in FIG. 3.

In Step 240 of FIG. 2, Pjob verifies whether or not the user is really a legal registered user of the user management server (Ss) by the following procedure:

Step 4.1. Pjob gets the access tickets TPjob-Ss for the user management server (Ss) from SA through the procedure described in step 230.

Step 4.2. Pjob authenticates itself to the user management server (Ss) by presenting its access ticket TPjob-Ss.

Step 4.3. Pjob sends user's name and password to Ss through a secure channel. This secure channel is set up through the secret key included in TPjob-Ss. Ss verify the user name and password by querying its database and send back a YES/NO information.

In Step 245, a determination is made whether or not the user is a legal registered user. If the user is not a legal user, the process is aborted.

In Step 250, if the user is the legal user of the user management server (Ss), then Pjob creates the privilege table for the print job by the following procedure:

Step 5.1. Pjob gets the access tickets (TPjob-Sr1, . . . , TPjob-Srm) for those user management servers (Sr1, . . . , Sm) from SA through the procedure described in step 230.

Step 5.2. Pjob authenticates itself to each of those user management servers Sr1 through Sm by presenting TPjob-Sr1 through TPjob-Srm respectively.

Step 5.3. Sr1, . . . , Sm allows Pjob to pull out all user names that has been stored in these servers through secure channels and let user select intended job receivers. Each secure channel is set up through the secret key included in the access ticket TPjob-Sr1 through TPjob-Srm.

Step 5.4. Pjob allows the user to select different access right for each intended job receiver.

Step 5.5. Pjob produces a privilege table for the print job. A sample privilege table is given and described below.

In Step 260, Pjob sends the print job and its corresponding privilege table to those intended print server by the following procedure:

Step 6.1. Pjob gets the access tickets (TPjob-Sp1, . . . , TPjob-Spm) for those print servers (Sp1, . . . , Spm) from SA through the procedure described in step 230.

Step 6.2. Pjob authenticates itself to each print server Sp through Spm by presenting TPjob-Sp1 through TPjob-Spm respectively.

Step 6.3. Pjob sends the print job to each print server Sp1 through Spm respectively through secure channels. Each secure channel is set up through the secret key included in the access ticket TPjob-Sp1 through TPjob-Spm.

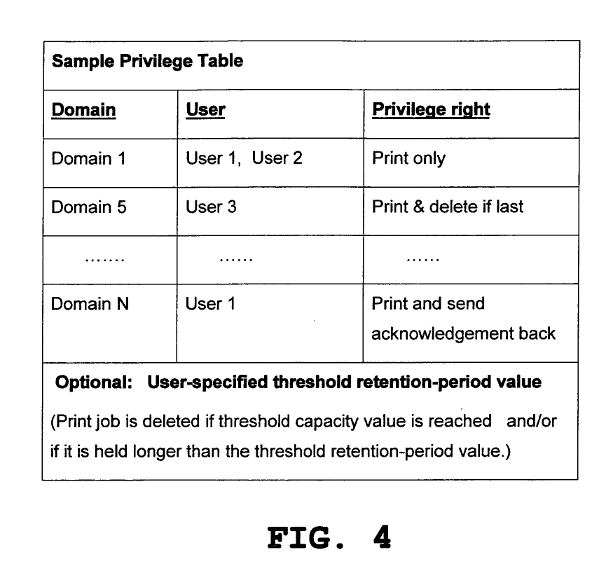

FIG. 4 shows a sample privilege table, in accordance with a preferred embodiment of the present invention. For each printable job, we provide a privilege table that allows different user across different domains to have different access rights to this file and print job. The particular combination of access rights would be specified and entered by the job-issuing user, where those unspecified entries may be appropriately set to the default settings. The access rights include: print only, print and delete if last, print and save, print and send acknowledgement message back to the job issuer, etc. depending on the information sensitivity of the print job.

The access right of print only is self-explanatory, and means print and take no further action. The access right of print and delete if last would specify that when all the recipients of the print job has accessed or printed the print job, then the print job should be deleted to make room in the storage component. Where there is only one recipient, print and delete if last is the same as print and delete. The access right of print and send acknowledgement message back to the job issuer enables notification by email and other means of the printing event to the job-issuing user.

The sample privilege table shown in FIG. 4 may be created and attached to a print job. In a sample privilege table for a print job, User1 and User2 in Domain1 are given the access right of Print only, User3 in Domain5 is given the access right of Print & delete if last, and User1 in yet another domain DomainN is given the access right of Print and send acknowledgement back.

The job-issuing user may optionally specify a threshold retention-period value, and if so, this value is included in the privilege table as well. A print job sent to and held at the destination print server is deleted if the print job is the oldest print job held at the destination print server and a possibly weighted combination of the following two criteria. First, the storage capacity of the destination print server exceeds a threshold capacity value, and second, the print job is held at the destination print server longer than a threshold retention-period value. This ensures that a print job is held and kept at the print server for too long a period, wasting valuable storage resources.

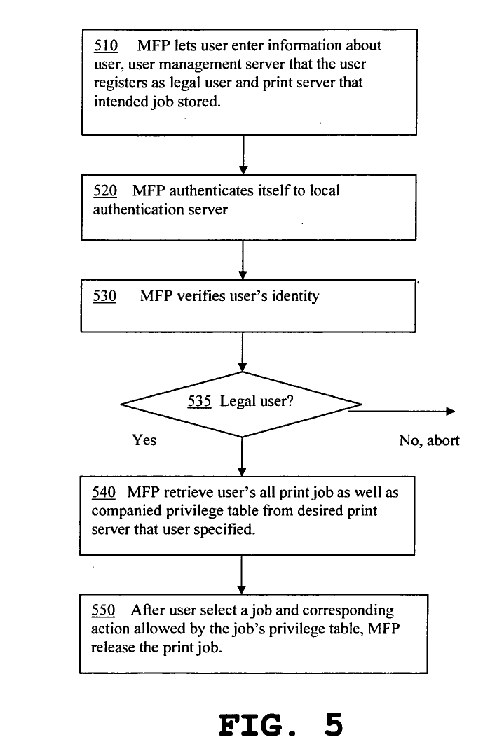

FIG. 5 is a flowchart showing the processing steps for a procedure of an MFP retrieving and releasing a print job from a server, in accordance with a preferred embodiment of the present invention. The procedure of how a user retrieves and releases a job through a MFP from a certain print server is illustrated in FIG. 5 as well as described as follows.

In Step 510, the user first enters the following information into MFP:

Step 1.1. User's name, password and the information of user management server Sr where his name and password is registered.

Step 1.2. Information of Print server (Sp) where the intended job is stored.

In Step 520, the MFP authenticates itself to the authentication server SA that sits in the same domain as MFP. By SA authenticating MFP, we mean SA issues a shared secret key K for future encrypted communication between MFP and SA. This shared secret K is encrypted by a pre-shared secrete between MFP and SA.

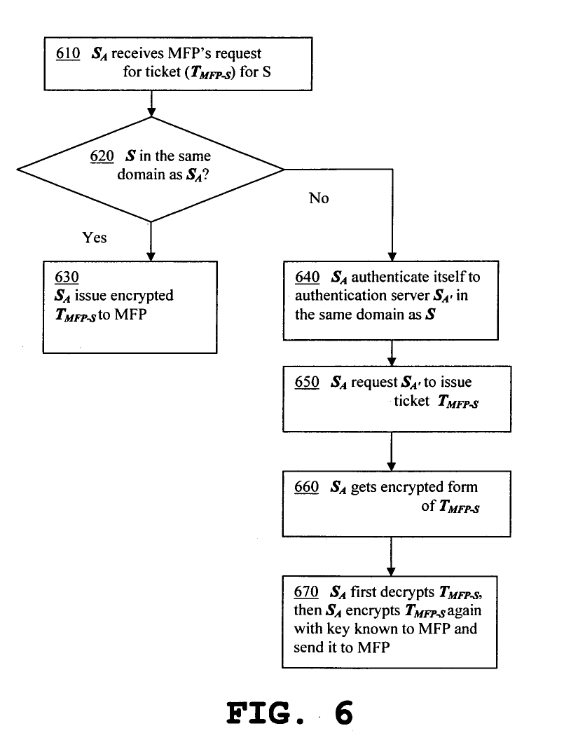

FIG. 6 is a flowchart showing the processing steps for a procedure of authentication server issuing an MFP an access ticket for other print servers or user management servers, in accordance with a preferred embodiment of the present invention. From this point on, the future communication between SA and MFP will be SA issuing MFP access ticket for some other server S based on MFP'S request in the following way: first MFP asks SA for the access ticket for other servers S such as user management server and print server in the same or different domain, SA replies MFP with the access ticket encrypted by K. If the server S is in a different domain with SA, then SA has to connect to the authentication server that sits in the same domain as S first. The procedure of SA issues MFP the access ticket for sever S is better illustrated in FIG. 6.

In Step 530 of FIG. 5, the MFP verifies whether or not the user is really as he claims to be the legal registered user of the user management server (Sr) by the following procedure:

Step 3.1: MFP get the access ticket TMFP-Sr for Sr from SA using the procedure described in Step 520.

Step 3.2: MFP authenticates itself to the user management server (Sr) by presenting his ticket TMFP-Sr to Sr.

Step 3.3: MFP sends user's name and password to the user management server Sr through a secure channel. This secure channel is set up through the secret key included in the access ticket TMFP-Sr.

Step 3.4: The User management server (Sr) verifies the user name and password by querying its database and send back YES/NO information.

In Step 535, a determination is made whether or not the user is a legal registered user. If the user is not a legal user, the process is aborted.

In Step 540, if the user is a legal user, MFP retrieves the intended print job for user by the following procedure:

Step 4.1. MFP gets access ticket TMFP-Sp for the print server (Sp) from SA using the procedure described in Step 520.

Step 4.2. MFP authenticates itself to the print server (Sp) by presenting TMFP-Sp to Sp.

Step 4.3. MFP sends user's name to the Print server Sp through a secure channel. This secure channel is set up through the secret key included in the access ticket TMFP-Sp.

Step 4.4. Print server (Sp) queries all print jobs that the user has on that print server based on each job's privilege table information and sends all the result print jobs and their accompanied privilege right back to the MFP through the same secure channel set up in step 4.3.

In Step 550, after the user selects print jobs displayed by the MFP, user also select some actions that he want MFP to operate on this print job allowed by the privilege table that accompanies the print job, then the print job will be handled in the corresponding way the user selected.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although the terminology and description of this invention may seem to have assumed a certain platform, one skilled in this art could see how the disclosed methods can be used with other operating systems, such as Windows, DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A method for secure communication of a print job to a printing device, comprising:
a job-issuing user entering to a job-issuing package user identification information, at least one allowable action for at least one job-receiving user, and a destination print server for the print job;
the job-issuing package creating and attaching a privilege table comprising the entered at least one allowable action for at least one job-receiving user to the print job, and sending the print job with the attached privilege table to the destination print server for the print job;
a job-receiving user entering into the printing device user identification information and a destination print server for the print job;
the printing device retrieving at least one print job with the attached privilege table from the print server; and
upon verifying that the job-receiving user selects a print job and action allowed according to the privilege table for the print job, the printing device releasing the print job.

2. The method of claim 1, wherein the job-issuing user entering user identification information comprises the job-issuing user entering user identification information (of the job-issuing user) for a user management server, and user management server of at least one job-receiving user; and
wherein the job-receiving user entering into the printing device user identification information comprises the job-receiving user entering into the printing device user identification information (about the job-receiving user), a user management server for the job-receiving user, and a destination print server for the print job;

3. The method of claim 1, wherein, before the job-issuing package creating and attaching a privilege table to the print job, the job-issuing package authenticates itself to a local authentication server, and unless the job-issuing user is verified to be legal according to the entered user identification information, the communication is aborted; and
wherein, before the printing device retrieving at least one print job with the attached privilege table from the print server, the printing device authenticates itself to a local authentication server, and unless the job-receiving user is verified to be legal according to the entered user identification information, the communication is aborted.

4. The method of claim 1, before the job-issuing package creating and attaching a privilege table to the print job, further comprising:
the job-issuing package authenticating itself to a local authentication server;
the job-issuing package requesting an access ticket for a first server from the authentication server;
the authentication server issuing an encrypted access ticket for the first server from the authentication server if the first server is in the same domain as the authentication server;
and, if the first server and the authentication server are in different domains, the authentication server authenticating itself to a second authentication server in the same domain as the first server;
the authentication server requesting to the second authentication server to issue an access ticket;
the authentication server receiving an encrypted access ticket;
the authentication server decrypting the encrypted access ticket, encrypting the access ticket with a key known to the job-issuing package, and sending the encrypted access ticket to the job-issuing package.

5. The method of claim 1, before the printing device retrieving at least one print job with the attached privilege table from the print server, further comprising:
the printing device authenticating itself to a local authentication server;
the printing device requesting an access ticket for a first server from the authentication server;
the authentication server issuing an encrypted access ticket for the first server from the authentication server if the first server is in the same domain as the authentication server;
and, if the first server and the authentication server are in different domains, the authentication server authenticating itself to a second authentication server in the same domain as the first server;
the authentication server requesting to the second authentication server to issue an access ticket;
the authentication server receiving an encrypted access ticket;
the authentication server decrypting the encrypted access ticket, encrypting the access ticket with a key known to the printing device, and sending the encrypted access ticket to the job-issuing package.

6. The method of claim 1, wherein the at least one allowable action for at least one job-receiving user comprises print only, print and delete if last, and print and send acknowledgement back.

7. The method of claim 1, wherein the print job with attached privilege table sent to the destination print server can be retrieved by at least two job-receiving users using at least two printing devices sitting in different domains, each of which domains contains its own authentication server.

8. The method of claim 1, wherein a print job sent to and held at the destination print server is deleted if the print job is the oldest print job held at the destination print server and the storage capacity of the destination print server exceeds a threshold capacity value and/or if the print job is held at the destination print server longer than a threshold retention period value, wherein optionally the threshold retention period value is entered by the job-issuing user to the job-issuing package and encoded within the privilege table attached to the print job.

9. A computer program product for secure communication of a print job to a printing device, comprising machine-readable code for causing a machine to perform the method steps of:
a job-issuing user entering to a job-issuing package user identification information, at least one allowable action for at least one job-receiving user, and a destination print server for the print job;
the job-issuing package creating and attaching a privilege table comprising the entered at least one allowable action for at least one job-receiving user to the print job, and sending the print job with the attached privilege table to the destination print server for the print job;
a job-receiving user entering into the printing device user identification information and a destination print server for the print job;
the printing device retrieving at least one print job with the attached privilege table from the print server; and
upon verifying that the job-receiving user selects a print job and action allowed according to the privilege table for the print job, the printing device releasing the print job.

10. The computer program product of claim 9, wherein the job-issuing user entering user identification information comprises the job-issuing user entering user identification information (of the job-issuing user) for a user management server, and user management server of at least one job-receiving user; and
wherein the job-receiving user entering into the printing device user identification information comprises the job-receiving user entering into the printing device user identification information (about the job-receiving user), a user management server for the job-receiving user, and a destination print server for the print job;

11. The computer program product of claim 9, wherein, before the job-issuing package creating and attaching a privilege table to the print job, the job-issuing package authenticates itself to a local authentication server, and unless the job-issuing user is verified to be legal according to the entered user identification information, the communication is aborted; and
wherein, before the printing device retrieving at least one print job with the attached privilege table from the print server, the printing device authenticates itself to a local authentication server, and unless the job-receiving user is verified to be legal according to the entered user identification information, the communication is aborted.

12. The computer program product of claim 9, before the job-issuing package creating and attaching a privilege table to the print job, further comprising:
the job-issuing package authenticating itself to a local authentication server;
the job-issuing package requesting an access ticket for a first server from the authentication server;
the authentication server issuing an encrypted access ticket for the first server from the authentication server if the first server is in the same domain as the authentication server;
and, if the first server and the authentication server are in different domains, the authentication server authenticating itself to a second authentication server in the same domain as the first server;
the authentication server requesting to the second authentication server to issue an access ticket;
the authentication server receiving an encrypted access ticket;
the authentication server decrypting the encrypted access ticket, encrypting the access ticket with a key known to the job-issuing package, and sending the encrypted access ticket to the job-issuing package; and
before the printing device retrieving at least one print job with the attached privilege table from the print server, further comprising:
the printing device authenticating itself to a local authentication server;
the printing device requesting an access ticket for a first server from the authentication server;
the authentication server issuing an encrypted access ticket for the first server from the authentication server if the first server is in the same domain as the authentication server;
and, if the first server and the authentication server are in different domains, the authentication server authenticating itself to a second authentication server in the same domain as the first server;
the authentication server requesting to the second authentication server to issue an access ticket;
the authentication server receiving an encrypted access ticket;
the authentication server decrypting the encrypted access ticket, encrypting the access ticket with a key known to the printing device, and sending the encrypted access ticket to the job-issuing package.

13. The computer program product of claim 9, wherein the at least one allowable action for at least one job-receiving user comprises print only, print and delete if last, and print and send acknowledgement back.

14. The computer program product of claim 9, wherein the print job with attached privilege table sent to the destination print server can be retrieved by at least two job-receiving users using at least two printing devices sitting in different domains, each of which domains contains its own authentication server; and
wherein a print job sent to and held at the destination print server is deleted if the print job is the oldest print job held at the destination print server and the storage capacity of the destination print server exceeds a threshold capacity value and/or if the print job is held at the destination print server longer than a threshold retention period value, wherein optionally the threshold retention period value is entered by the job-issuing user to the job-issuing package and encoded within the privilege table attached to the print job.

15. A computing system comprising a print engine for secure communication of a print job to a printing device, comprising:
a job-issuing user entering to a job-issuing package user identification information, at least one allowable action for at least one job-receiving user, and a destination print server for the print job;
the job-issuing package creating and attaching a privilege table comprising the entered at least one allowable action for at least one job-receiving user to the print job, and sending the print job with the attached privilege table to the destination print server for the print job;
a job-receiving user entering into the printing device user identification information and a destination print server for the print job;
the printing device retrieving at least one print job with the attached privilege table from the print server; and
upon verifying that the job-receiving user selects a print job and action allowed according to the privilege table for the print job, the printing device releasing the print job.

16. The computing system of claim 15, wherein the job-issuing user entering user identification information comprises the job-issuing user entering user identification information (of the job-issuing user) for a user management server, and user management server of at least one job-receiving user; and
wherein the job-receiving user entering into the printing device user identification information comprises the job-receiving user entering into the printing device user identification information (about the job-receiving user), a user management server for the job-receiving user, and a destination print server for the print job;

17. The computing system of claim 15, wherein, before the job-issuing package creating and attaching a privilege table to the print job, the job-issuing package authenticates itself to a local authentication server, and unless the job-issuing user is verified to be legal according to the entered user identification information, the communication is aborted; and
wherein, before the printing device retrieving at least one print job with the attached privilege table from the print server, the printing device authenticates itself to a local authentication server, and unless the job-receiving user is verified to be legal according to the entered user identification information, the communication is aborted.

18. The computing system of claim 15, before the job-issuing package creating and attaching a privilege table to the print job, further comprising:
the job-issuing package authenticating itself to a local authentication server;
the job-issuing package requesting an access ticket for a first server from the authentication server;
the authentication server issuing an encrypted access ticket for the first server from the authentication server if the first server is in the same domain as the authentication server;
and, if the first server and the authentication server are in different domains, the authentication server authenticating itself to a second authentication server in the same domain as the first server;
the authentication server requesting to the second authentication server to issue an access ticket;
the authentication server receiving an encrypted access ticket;
the authentication server decrypting the encrypted access ticket, encrypting the access ticket with a key known to the job-issuing package, and sending the encrypted access ticket to the job-issuing package; and
before the printing device retrieving at least one print job with the attached privilege table from the print server, further comprising:
the printing device authenticating itself to a local authentication server;
the printing device requesting an access ticket for a first server from the authentication server;
the authentication server issuing an encrypted access ticket for the first server from the authentication server if the first server is in the same domain as the authentication server;
and, if the first server and the authentication server are in different domains,
the authentication server authenticating itself to a second authentication server in the same domain as the first server;
the authentication server requesting to the second authentication server to issue an access ticket;
the authentication server receiving an encrypted access ticket;
the authentication server decrypting the encrypted access ticket, encrypting the access ticket with a key known to the printing device, and sending the encrypted access ticket tb the job-issuing package.

19. The computing system of claim 15, wherein the at least one allowable action for at least one job-receiving user comprises print only, print and delete if last, and print and send acknowledgement back.

20. The computing system of claim 15, wherein the print job with attached privilege table sent to the destination print server can be retrieved by at least two job-receiving users using at least two printing devices sitting in different domains, each of which domains contains its own authentication server; and
wherein a print job sent to and held at the destination print server is deleted if the print job is the oldest print job held at the destination print server and the storage capacity of the destination print server exceeds a threshold capacity value and/or if the print job is held at the destination print server longer than a threshold retention period value, wherein optionally the threshold retention period value is entered by the job-issuing user to the job-issuing package and encoded within the privilege table attached to the print job.
